(19) United States
(12) Patent Application Publication
(10) Pub. No.: US 2022/0392653 A1
(43) Pub. Date: Dec. 8, 2022

(54) EXTERNAL REACTOR VESSEL COOLING SYSTEM FOR FLOATING NUCLEAR POWER PLANTS

(71) Applicant: Harbin Engineering University, HARBIN (CN)

(72) Inventors: GENGLEI XIA, HARBIN (CN); MINJUN PENG, HARBIN (CN); QIANG ZHAO, HARBIN (CN); CHENYANG WANG, HARBIN (CN); YUANDONG ZHANG, HARBIN (CN); JILIN SUN, HARBIN (CN); BOWEN ZHANG, HARBIN (CN); XUE DU, HARBIN (CN)

(21) Appl. No.: 17/746,773

(22) Filed: May 17, 2022

(30) Foreign Application Priority Data
Jun. 2, 2021 (CN) 2021106148604

(51) Int. Cl. G21C 13/024; G21C 13/10; G21C 15/247; G21C 15/28

(52) U.S. Cl. CPC G21C 13/024; G21C 13/10; G21C 15/247; G21C 15/28

(57) ABSTRACT

An ERVC for floating nuclear power plants includes a containment, a reactor vessel, a liquid gallium collection tank, a heat pipe, a cooling cabin and a gallium storage tank. The containment is arranged in a sea environment, and the containment is provided with a containing cavity; the reactor vessel and the liquid gallium collection tank are arranged up and down and located in the containing cavity. An end of the heat pipe is inserted into the liquid gallium collection tank, and another end thereof is arranged outside the liquid gallium collection tank; the gallium storage tank is located in the containing cavity; the gallium storage tank is connected to the liquid gallium collection tank through a liquid gallium release valve; and the cooling cabin is located under the containment and under a sea level of the sea environment.

### CROSS-REFERENCE TO RELATED APPLICATION

This application claims priority to Chinese Patent Application No. 2021106148604, filed on Jun. 2, 2021, the content of which is hereby incorporated by reference in its entirety.

### TECHNICAL FIELD

The present application relates to the technical field of nuclear reactor engineering, and in particularly relates to an external reactor vessel cooling system for floating nuclear power plants, which uses liquid gallium as an intermediate heat transfer medium and uses a heat pipe to transfer heat.

### BACKGROUND

Floating nuclear power plants can be used for power generation and seawater desalination, and can meet special requirements such as regional power supply, offshore oil exploitation, isolated islands, etc. Improving the safety of floating nuclear power plants (or reducing assumed serious accidents) is a key to a design of floating nuclear power plants. An In-vessel retention (IVR) is one of key strategies for many advanced reactor designs to reduce assumed serious accidents. A success of the IVR largely depends on an external reactor vessel cooling system (ERVC), and a decay heat is discharged from a molten core of a lower head of a reactor vessel through the ERVC.

A conventional ERVC involves flooding the reactor cavity to submerge the reactor vessel to cool the core debris by boiling heat transfer, which maintains the integrity of the reactor vessel. As a result, the conventional ERVC has following three defects. (1) A large amount of steam is generated in the runner, which leads to the risk that the runner outlet is blocked and a heat flux at an equatorial position of the lower head exceeds a critical heat flux limit, and then causes a melt to penetrate the reactor vessel. (2) A large amount of steam is generated in a containment, which may cause an overpressure of the containment to threaten an integrity of the containment. (3) Because a pit water keeps heating up, the conventional ERVC can't run for a long time. When a temperature is high enough, the conventional ERVC will lose its cooling capacity.

Therefore, there is an urgent need for a safer, more stable and more reliable ERVC suitable for floating nuclear power plants.

### SUMMARY

The main objective of the present application is to provide an ERVC for floating nuclear power plants, which uses liquid gallium as an intermediate heat transfer medium and a heat pipe to transfer heat. The technical solutions are as follows.

An ERVC for floating nuclear power plants is provided, which includes a containment, a reactor vessel, a liquid gallium collection tank, a heat pipe, a cooling cabin and a gallium storage tank; the containment is configured to be arranged in a sea environment, and the containment is provided with a containing cavity; the reactor vessel and the liquid gallium collection tank are arranged up and down and both located in the containing cavity of the containment, and a lower head of the reactor vessel is arranged in the liquid gallium collection tank; an end of the heat pipe is inserted into the liquid gallium collection tank and configured to be an evaporation section; and another end of the heat pipe is arranged outside the liquid gallium collection tank at a side facing away from the reactor vessel, and is fixedly connected to an inner wall of a bottom of the containment and configured to be a condensation section; the gallium storage tank is located in the containing cavity of the containment and is arranged outside the liquid gallium collection tank, and the gallium storage tank is connected to the liquid gallium collection tank; the cooling cabin is arranged under the containment; an end of the cooling cabin is connected to an outlet of a seawater inlet valve, and another end of the cooling cabin is connected to an inlet of the seawater outlet valve; an inlet of the seawater inlet valve and an outlet of the seawater outlet valve are both connected to the sea environment; and the seawater inlet valve, the cooling cabin and the seawater outlet valve together form a flow channel of seawater.

In an embodiment, a liquid gallium release valve is arranged between the gallium storage tank and the liquid gallium collection tank; the gallium storage tank is internally provided with a pressurized argon gas, a liquid gallium and an auxiliary heater, the pressurized argon gas is located in an upper space of the gallium storage tank, the liquid gallium is located in a lower space of the gallium storage tank, and the auxiliary heater is arranged inside the liquid gallium; and the lower space of the gallium storage tank is connected to the liquid gallium collection tank through a connecting pipe, and the liquid gallium release valve is arranged on the connecting pipe.

In an embodiment, the auxiliary heater is configured to control the liquid gallium to remain liquid.

In an embodiment, the liquid gallium collection tank has a storage cavity, and the storage cavity is defined by a vessel wall of the lower head of the reactor vessel and a housing of the liquid gallium collection tank.

In an embodiment, the storage cavity of the liquid gallium collection tank is in vacuum.

In an embodiment, the gallium storage tank is arranged at a position higher than an upper end surface of the liquid gallium collection tank.

In an embodiment, the seawater inlet valve, the seawater outlet valve and the liquid gallium release valve each are in a powered-on and turned-off state when no core meltdown accident occurs, and the seawater inlet valve, the seawater outlet valve and the liquid gallium release valve each are in a powered-off and turned-on state when a core meltdown accident occurs.

In an embodiment, the seawater inlet valve, the seawater outlet valve and the liquid gallium release valve each are an electromagnetic valve.

In an embodiment, the seawater inlet valve, the cooling cabin and the seawater outlet valve are all located under a sea level of the sea environment.

In an embodiment, the circulating working medium of the heat pipe is water, and the evaporation section of the heat pipe is provided with a fin.

The present application may have the following advantages.

1. Compared with the conventional ERVC, the present application utilizes a heat pipe to transfer a decay heat to an inner wall surface of a bottom of a steel containment, then a circulating seawater washes and cools an outer wall surface of the bottom of the steel containment in a cooling cabin, and uses a sea environment as an ultimate heat sink. Since the present ERVC is not at risk of failure caused by a loss of the heat sink, the present application has the advantages of a good safety, a good stability and a long-term operation.

2. The present application will not generate a large amount of steam inside the containment, thus avoiding problems of runner blockage and overpressure of the containment.

3. The present application relies on a gas pressure difference and a gravity pressure difference to drive liquid gallium from the gallium storage tank to the liquid gallium collection tank, so it has the characteristics of a quick action and a high inherent safety. The liquid gallium collection tank, the liquid gallium release valve and the gallium storage tank form a closed environment, thereby effectively preventing a toxic gallium from volatilizing into the containment. Because the gallium storage tank is filled with a pressurized argon gas, the tank can automatically stabilize a pressure fluctuation of the closed environment composed of the liquid gallium collection tank, the liquid gallium release valve and the gallium storage tank in case of accidents.

4. Compared with the conventional ERVC, the present application uses a liquid gallium as an intermediate heat transfer medium. The liquid gallium has high thermal conductivity and can effectively reduce the heat flux at the equatorial position of the reactor vessel and greatly reduce the risk of melt-through of the reactor vessel. Further, the liquid gallium has a high boiling point, an outside of the reactor vessel will not boil, thus avoiding a heat transfer deterioration caused by flow boiling.

### BRIEF DESCRIPTION OF DRAWINGS

FIG. 1 is a schematic diagram of an overall structural arrangement of an ERVC for floating nuclear power plants according to an embodiment of the present application.

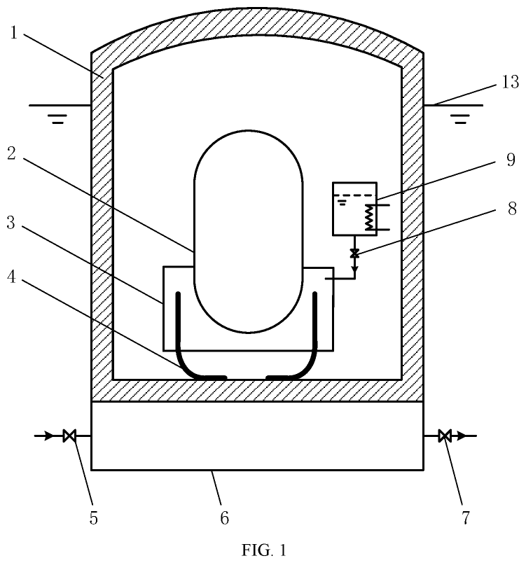

FIG. 2 is a schematic diagram of an internal structure of a gallium storage tank according to an embodiment of the present application.

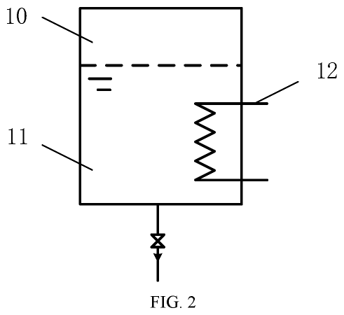

### DETAILED DESCRIPTION OF EMBODIMENTS

### Embodiment 1

An ERVC for floating nuclear power plants includes a containment 1, a reactor vessel 2, a liquid gallium collection tank 3, a heat pipe 4, a cooling cabin 6 and a gallium storage tank 9.

The containment 1 is used for being arranged in a sea environment 13, and the containment 1 has a containing cavity.

The reactor vessel 2 and the liquid gallium collection tank 3 are arranged up and down and located in the containing cavity of the containment 1; and a lower head of the reactor vessel 2 is arranged in the liquid gallium collection tank 3.

An end of the heat pipe 4 is inserted into the liquid gallium collection tank 3 and used to be an evaporation section; and another end of the heat pipe 4 is arranged outside the liquid gallium collection tank 3 at a side facing away from the reactor vessel 2, and is fixedly connected to an inner wall of a bottom of the containment 1 and used to be a condensation section.

In a preferred embodiment, the circulating working medium of the heat pipe 4 is water, and the evaporation section of the heat pipe 4 is provided with a fin.

The evaporation section of the heat pipe 4 is inserted into the liquid gallium collection tank 3, but it is not connected to the reactor vessel 2. The condensation section is connected to the inner wall of the bottom of the containment 1. In case of accidents, the heat pipe 4 could transfer a heat of a liquid gallium 11 to the inner wall of the bottom of the containment 1, and then the heat is transferred to an outer wall of the bottom of the containment 1 in a heat conduction manner.

The gallium storage tank 9 is located in the containing cavity of containment 1, and is arranged outside the liquid gallium collection tank 3, and is arranged at a position higher than an upper surface of the liquid gallium collection tank 3. The gallium storage tank 9 is connected to the liquid gallium collection tank 3. A liquid gallium release valve 8 is arranged between the gallium storage tank 9 and the liquid gallium collection tank 3. An end of the liquid gallium release valve 8 is connected to an outlet of the gallium storage tank 9, and another end of the liquid gallium release valve 8 is connected to an inlet of the liquid gallium collection tank 3.

In the embodiment, a seawater inlet valve 5, a cooling cabin 6 and a seawater outlet valve 7 are all located under a sea level of the sea environment 13; the cooling cabin 6 is arranged under the containment 1; an end of the cooling cabin 6 is connected to an outlet of the seawater inlet valve 5, and another end of the cooling cabin is connected to an inlet of the seawater outlet valve 7; an inlet of the seawater inlet valve 5 and the outlet of the seawater outlet valve 7 are both connected to the sea environment 13; and the seawater inlet valve 5, the cooling cabin 6 and the seawater outlet valve 7 form a flow channel of seawater.

In this embodiment, a pressurized argon gas 10, a liquid gallium 11 and an auxiliary heater 12 are arranged in the gallium storage tank 9; the pressurized argon gas 10 is located in an upper space of the gallium storage tank 9, the liquid gallium 11 is located in a lower space of the gallium storage tank 9, and the auxiliary heater 12 is arranged inside the liquid gallium 11; and the lower space of the gallium storage tank 9 is connected to the liquid gallium collection tank 3 through a connecting pipe, and the liquid gallium release valve 8 is arranged on the connecting pipe. The auxiliary heater 12 controls the liquid gallium 11 to remain liquid.

The liquid gallium collection tank 3 has a storage cavity, the storage cavity is defined by a vessel wall of the lower head of the reactor vessel 2 and a housing of the liquid gallium collection tank 3. The storage cavity of the liquid gallium collection tank 3 is in vacuum.

The seawater inlet valve 5, the seawater outlet valve 7 and the liquid gallium release valve 8 each are in a powered-on and turned-off state when no core meltdown accident occurs, and the seawater inlet valve 5, the seawater outlet valve 7 and the liquid gallium release valve 8 each are in a powered-off and turned-on state when a core meltdown accident occurs.

Specifically, when no core meltdown accident occurs, the liquid gallium release valve 8 is in the powered-on and turned-off state, and the liquid gallium 11 is stored in the gallium storage tank 9 and remains liquid under the control of the auxiliary heater 12. When a core meltdown accident occurs, the liquid gallium release valve 8 is in the powered-on and turned-off state, and the liquid gallium 11 enters the liquid gallium collection tank 3 under an action of a gas pressure difference and a gravity differential pressure, and a decay heat in a molten pool is transferred to the liquid gallium 11 in the liquid gallium collection tank 3 by conducting a heat through the lower head of the reactor vessel 2.

In this embodiment, the seawater inlet valve 5, the seawater outlet valve 7 and the liquid gallium release valve 8 each are an electromagnetic valve. In other embodiments, the seawater inlet valve 5, the seawater outlet valve 7 and the liquid gallium release valve 8 can also be other valves with the same function.

The working principle of this embodiment is as follows.

When there is no core meltdown accident, the seawater inlet valve 5, the seawater outlet valve 7 and the liquid gallium release valve 8 each are in a powered-on and turned-off state; the liquid gallium 11 in the lower space of the gallium storage tank 9 remains liquid under the control of the auxiliary heater 12, the pressurized argon gas 10 in the upper space of the gallium storage tank 9 is pre-charged with a certain pressure, the liquid gallium collection tank 3 is kept in a vacuum, and the gallium storage tank 9 is arranged at a position higher than the liquid gallium collection tank 3, so that a gravity differential pressure and a gas pressure difference are established between an interior of the gallium storage tank 9 and the storage cavity of the liquid gallium collection tank 3. Further, because the seawater inlet valve 5 and the seawater outlet valve 7 each are in a powered-on and turned-off state, there is no circulating flow in the cooling cabin 6.

When a core meltdown accident occurs, the seawater inlet valve 5, the seawater outlet valve 7 and the liquid gallium release valve 8 each are in a powered-off and turned-on state; the liquid gallium 11 enters the liquid gallium collection tank 3 from the gallium storage tank 9 under the action of a gravity differential pressure and a gas pressure difference; the decay heat in the molten pool is transferred to the liquid gallium 11 in the liquid gallium collection tank 3 by conducting heat through the lower head of the reactor vessel 2; the heat pipe 4 transfers the heat of the liquid gallium 11 to the inner wall surface of the bottom of the containment 1, and then transfers the heat to the outer wall surface of the bottom of the containment 1 by heat conduction. Further, as the seawater inlet valve 5 and the seawater outlet valve 7 each are in a powered-off and turned-on state, a seawater in the sea environment 13 enters the cooling cabin 6 through the seawater inlet valve 5, washes and cools the outer wall surface of the bottom of the containment 1, and then flows into the sea environment 13 through the seawater outlet valve 7.

The above description is only preferred embodiments of the present application, and does not limit the technical scope of the present application in any way. Therefore, any slight modifications, equivalent changes and modifications of the above embodiments according to the technical essence of the present application still belongs to the technical solutions of the present application.

What is claimed is:

1. An external reactor vessel cooling system (ERVC) for floating nuclear power plants, comprising: a containment, a reactor vessel, a liquid gallium collection tank, a heat pipe, a cooling cabin and a gallium storage tank;
wherein the containment is configured to be arranged in a sea environment, and the containment is provided with a containing cavity;
wherein the reactor vessel and the liquid gallium collection tank are arranged up and down and both located in the containing cavity of the containment, and a lower head of the reactor vessel is arranged in the liquid gallium collection tank;
wherein an end of the heat pipe is inserted into the liquid gallium collection tank and configured to be an evaporation section; another end of the heat pipe is arranged outside the liquid gallium collection tank at a side facing away from the reactor vessel, and is fixedly connected to an inner wall of a bottom of the containment and configured to be a condensation section;
wherein the gallium storage tank is located in the containing cavity of the containment and is arranged outside the liquid gallium collection tank, and the gallium storage tank is connected to the liquid gallium collection tank; and
wherein the cooling cabin is arranged under the containment; an end of the cooling cabin is connected to an outlet of a seawater inlet valve, and another end of the cooling cabin is connected to an inlet of the seawater outlet valve; an inlet of the seawater inlet valve and an outlet of the seawater outlet valve are both connected to the sea environment; and the seawater inlet valve, the cooling cabin and the seawater outlet valve together form a flow channel of seawater.

2. The ERVC for floating nuclear power plants according to claim 1, wherein a liquid gallium release valve is arranged between the gallium storage tank and the liquid gallium collection tank;
wherein a pressurized argon gas, a liquid gallium and an auxiliary heater are arranged in the gallium storage tank; the pressurized argon gas is located in an upper space of the gallium storage tank, the liquid gallium is located in a lower space of the gallium storage tank, and the auxiliary heater is arranged inside the liquid gallium; and
wherein the lower space of the gallium storage tank is connected to the liquid gallium collection tank through a connecting pipe, and the liquid gallium release valve is arranged on the connecting pipe.

3. The ERVC for floating nuclear power plants according to claim 2, wherein the auxiliary heater is configured to control the liquid gallium to remain liquid.

4. The ERVC for floating nuclear power plants according to claim 3, wherein the liquid gallium collection tank has a storage cavity, and the storage cavity is defined by a vessel wall of the lower head of the reactor vessel and a housing of the liquid gallium collection tank.

5. The ERVC for floating nuclear power plants according to claim 4, wherein the storage cavity of the liquid gallium collection tank is in vacuum.

6. The ERVC for floating nuclear power plants according to claim 5, wherein the gallium storage tank is arranged at a position higher than an upper end surface of the liquid gallium collection tank.

7. The ERVC for floating nuclear power plants according to claim 6, wherein the seawater inlet valve, the seawater outlet valve and the liquid gallium release valve each are in a powered-on and turned-off state when no core meltdown accident occurs; and the seawater inlet valve, the seawater outlet valve and the liquid gallium release valve each are in a powered-off and turned-on state in a condition that when a core meltdown accident occurs.

8. The ERVC for floating nuclear power plants according to claim 7, wherein the seawater inlet valve, the seawater outlet valve and the liquid gallium release valve each are an electromagnetic valve.

9. The ERVC for floating nuclear power plants according to claim 1, wherein the seawater inlet valve, the cooling cabin and the seawater outlet valve are all located under a sea level of the sea environment.

10. The ERVC for floating nuclear power plants according to claim 1, wherein a circulating working medium of the heat pipe is water, and the evaporation section of the heat pipe is provided with fins.
